(19) United States
(12) Patent Application Publication
(10) Pub. No.: US 2020/0254483 A1
(43) Pub. Date: Aug. 13, 2020

(54) METHOD OF TREATING A VESSEL TO ALLOW ADHERENCE OF AN EDIBLE COATING

(71) Applicants: Geoffrey J. ADDEO, Garden City, NY (US); Jill M. ADDEO, Garden City, NY (US); Ed GILCHREST, Oxford, CT (US)

(72) Inventors: Geoffrey J. ADDEO, Garden City, NY (US); Jill M. ADDEO, Garden City, NY (US); Ed GILCHREST, Oxford, CT (US)

(21) Appl. No.: 16/789,001

(22) Filed: Feb. 12, 2020

Related U.S. Application Data
(63) Continuation-in-part of application No. 16/540,278, filed on Aug. 14, 2019, now abandoned.
(60) Provisional application No. 62/718,605, filed on Aug. 14, 2018.

(51) Int. Cl. B05D 3/14; B65D 25/34; A61J 7/00; A23L 27/00; A23P 20/18

(52) U.S. Cl. CPC B05D 3/144; B65D 25/34; A23V 2002/00; A23L 27/70; A23P 20/18; A61J 7/0046

(57) ABSTRACT

A method for treating a polymer vessel, comprising treating a surface region of the vessel by exposing the surface region to a high-frequency plasma; and coating the surface region of the vessel with a lasting water-based edible coating. A vessel treated in accordance with the method. The method may include placing the vessel on a conveyor, a robotic arm or system to facilitate the movement of the vessel through the high-frequency plasma device. Including rotating the vessel to treat different parts thereof.

This application a continuation-in-part of application Ser. No. 16/540,278, filed on Aug. 14, 2019, which is a Section 111(a) application relating to and claims the benefit of commonly owned, co-pending U.S. Provisional Application Ser. No. 62/718,605 entitled “A METHOD FOR ADHERING AND EDIBLE COATING TO A PLASTIC VESSEL”, filed on Aug. 14, 2018, the entirety of which is incorporated herein by reference.

### BACKGROUND OF THE DISCLOSURE

### 1. Field of the Disclosure

The present disclosure relates to apparatus and methods for treating a polymer vessel, such as a polypropylene plastic vessel, by adjusting the surface energy of the vessel to become more accepting of a water-based, liquid, edible coating or solute.

### 2. Description of the Related Art

The use of various techniques for coating polypropylene plastic surfaces is well known in the art. Such adhesion methods rely on non-water-based additives, artificial substances, oils, and food stabilizers and food additives, and oils, and may include the use of wet chemicals, and high flames. However, by design, polypropylene vessels are resistant to the adherence of water-based coatings, preventing the detailed and precise application of coatings. In general, these methods fail to provide the at least temporary bond needed to keep coatings in place.

There is a need for a method that allows coatings to be readily applied and remain affixed to polymer surfaces.

### SUMMARY OF THE DISCLOSURE

In general, this disclosure is directed to the sustained adherence of a water-based coating on polypropylene, LDPE, HDPE and PTFE plastic vessels, or other polymers having low surface energy; that is below 38 mN/m. The method described herein is more desirable for both the environment and the consumer as compared to the methods mentioned above, and is chemical-free.

The method disclosed herein relies on effecting the surface tension of the polymer vessel to accept water-based coatings for at least temporary and for long-term adherence. This method allows for an edible coating on a variety of vessels and objects for mass consumer consumption. Vessels, utensils, and other plastic used for consumables can be coated with an edible coating applied to their surface, without the marked disadvantages mentioned above.

In accordance with the method disclosed herein a water-based coating is at least temporarily and in generally permanently applied to a polymer vessel such as one formed from polypropylene. The method comprises exposing a target region on the vessel to be coated with a high-frequency beam discharge to affect the surface tension of the vessel to allow for the coating to be affixed to the vessel. The high-voltage beam discharge can, in some applications, increases the wettability of the region exposed to the discharge.

The vessel can be exposed to at least one high-frequency beam, or corona field, which targets the region of the vessel to be coated. The high-frequency beam can be adjusted to provide the discharge, via a high-frequency plasma discharge device, at a determined and adjustable angle to ensure proper coverage. The vessel can pass through the high-frequency beam at a precise rate to ensure the polymer molecules in the precise region of the vessel receives the appropriate exposure to the beam. The method can further include the step of placing the vessel on a conveyor to facilitate the movement of the vessel through the high-voltage discharges of the high-frequency plasma discharge devices. The vessel can also be placed on, for example, a turntable, to rotate the vessel and expose different portions of the vessel to plasma. The movement can also be facilitated by a robotic system, handling a multitude or singular vessel per pass.

The effects of the beam(s), or corona field(s), can, in some applications be temporary. In those cases, the vessel is preferably coated within a period of time, or re-treating can be necessary. Once treated, the vessel is ready to accept a water-based coating via additional processing, as described below.

### BRIEF DESCRIPTION OF THE DRAWINGS

FIG. 1 is a perspective view of a coated vessel constructed in accordance with an embodiment; and

FIG. 2 is an enlarged, partial cross-sectional view of the coated vessel shown in FIG. 1;

FIG. 3 is an embodiment of a vessel being treated by the high-frequency plasma beam (corona field) device in accordance with an embodiment.

FIG. 4 is a flow chart of a method of manufacturing the vessel illustrated in FIGS. 1 and 2.

A component or a feature that is common to more than one drawing is indicated with the same reference number in each of the drawings.

### DESCRIPTION OF THE EMBODIMENTS

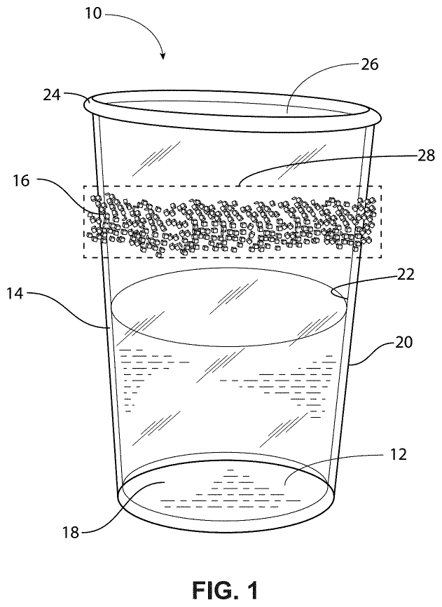

FIG. 1 illustrates an embodiment of a vessel 10 for holding liquid 12 for a user. Vessel 10 may be used to dispense liquids 12 such as an alcoholic beverage (e.g., a mixed drink or cocktail), juice, milk, water, soda, liquid medication and the like. In general, the vessel 10 includes a vessel portion 14 and a coating 16 on a wall thereof, such as the inner or outer wall.

Vessel portion 14 has a bottom portion 18, and a sidewall 20 with an interior surface 22 and a rim portion 24. The sidewall 20 extends upwardly from the bottom portion 18. Interior surface 22 of the sidewall 20 and the bottom portion 18 define an interior portion 26 configured to retain the liquid 12. The vessel portion 14 can be constructed using any suitable vessel known in the art. For example, the vessel portion 14 may be formed from an opaque plastic, transparent plastic, or a translucent plastic using any conventional vessel forming process. Vessel portion 14 may have calibrated measurement markings (not shown) satisfying FDA dosing standards.

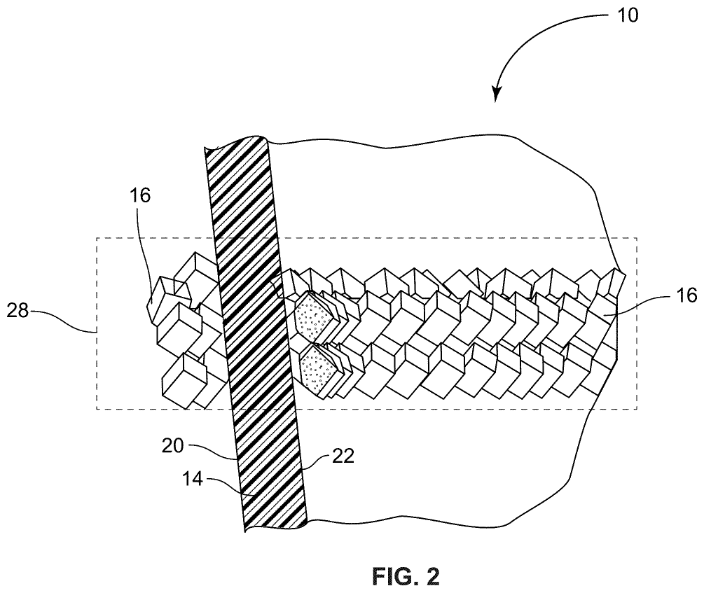

Turning to FIG. 2, coating 16 is applied to the treated portion 28 of the vessel 10. When the vessel 10 is used to dispense pediatric medications, coating 16 masks and chases the taste of the liquid medicine 12 making it more palatable for the user. Coating 16 is preferably made of a water-based liquid, which can also contain solids, sugar, natural colors, an acid component, and natural flavors, et al., without the aid of artificial ingredients, food-additives, chemicals, oils, or food stabilizers for adhesion. By way of example, and not by way of limitation, are solutions containing sugar, natural and/or artificial flavors; those containing sugar, water, natural and/or artificial flavors combined with sugar crystals and/or sprinkles, nonpareils; and those containing salt, water, natural and/or artificial flavors; and those containing salt, water, natural and/or artificial flavors, combined with sugars crystals and/or sprinkles, nonpareils.

Coating 16 can extend into the interior portion 26 of the vessel portion 14 from the interior surface 22 of the sidewall 20.

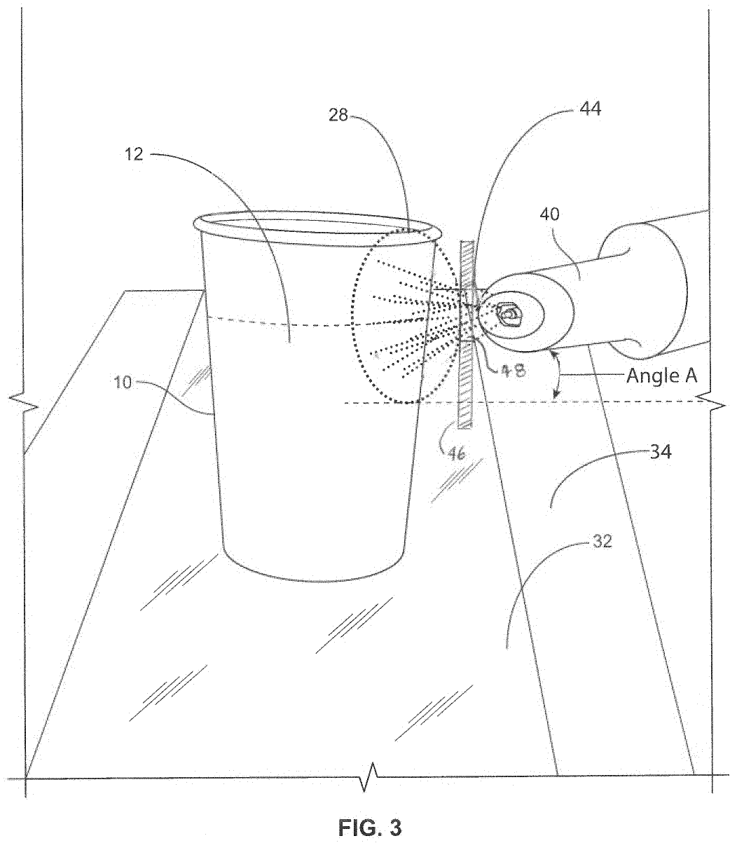

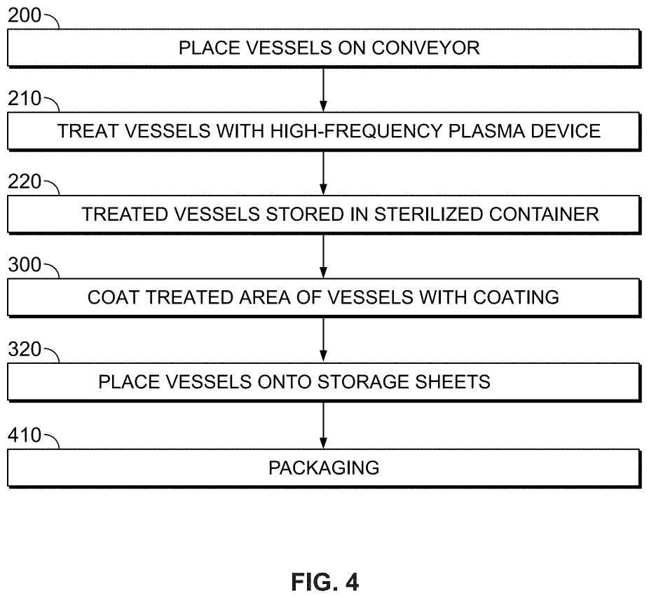

FIGS. 3 and 4 illustrate a method of manufacturing the vessel 10. Vessel 10 can be pre-sterilized before treating vessel 10 as described herein. In FIG. 4, at 200, one or more of vessel 10 is placing on a conveyor belt 32 (FIG. 3). At 210 vessel 10 is treated by high-frequency plasma discharge 44. Vessel 10 also can be stationary on a level surface 34. At 210, vessel 210 is treated using a high-frequency plasma or corona discharge 44 from the device 40. Treatment at 210 can include using more than one high-frequency plasma device 40. High-frequency plasma devices 40 are engaged and their generators are turned on. Preferably, the plasma discharge or corona discharge 44 frequency is adjusted to be in the range of approximately 25 kilohertz (kHz). Preferably, the high-frequency plasma discharge 44 is of a power of approximately 1100 watts and 6.5 kilovolts (kV) per device to ensure proper treatment. High-frequency plasma device 40 can form a discharge of plasma of approximately 45 to 65 millimeters (mm) wide and 5 to 20 millimeters (mm) in depth from the device 40 to assist in ensuring proper coverage. Conveyor 32 is then turned on. Vessels 10 move through the high-frequency plasma discharge or corona discharge 44 at a speed in the range of 3 to 18 meters (m) per minute to ensure the proper treatment of vessel 10.

Vessels 10 pass through the discharge 44 of the devices 30 at an angle A (FIG. 3). In an embodiment, the angle A of discharge 44 with respect to vessel 10 is within a range of about 0.0 to 5 degree to about 90 degrees depending on the region to be treated 28. Generally, an angle of 90 degrees with respect to the area to be treated provides optimal coverage. However, a preferred range is 90-75 degrees. In most cases the preferred operative range is 1-75 degrees. The temperature at which the process is conducted is preferable in the range of 64 to 79 degrees F., with the optimal temperature being 72 degrees. The relative humidity should be within a range of 15% to 45%, with the optimal being 30%. In general, the surface tension of the vessel 10 treated region 28 is adjusted from the vessel's natural state to at least 5 mN/m (dyn/cm) above a typical water-based solute's surface tension.

A mask 46, with an opening therein 48, can be provided to serve as a shield so that the portions of the vessel exposed to the plasma are limited as desired for a particular application.

At 220, treated vessels 10 can be stored in a sterilized container (not shown) for further manufacturing thereof. Each container can be labeled with the date of treatment.

At 300, vessel 10 can accept a water-based coating, solids, sugar, natural colors, an acid component, and natural flavors, etc., 16 without the aid of artificial ingredients, food-additives, chemicals, oils, or food stabilizers for adhesion, as in the prior art. At 300, vessel 10 is coated in the region 28 where it was treated, with, but not limited to, the water-based mixture 16. The water-based mixture (or solution) can be applied by dipping the vessel, spray coating, painting or in any other suitable way. Any excess of the water-based coating layer (which is either in liquid or semi-liquid form) 16 on the vessel 10 is wiped off in order to achieve the desired effect. At 320 vessel 10 can be placed on a storage sheet. At 410, treated vessels 10 are packaged for shipment to users.

In cases where more than one region of vessel 10 must accept a coating, multiple plasma generator devices may be utilized. Each device can treat a different region of the vessel 10.

It should be understood that the embodiments described herein are merely exemplary and that a person skilled in the art may make many variations and modifications without departing from the spirit and scope of the invention. All such variations and modifications are intended to be included within the scope of the invention as defined in the appended claims.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof

What is claimed is:

1. A method for treating a polymer vessel, comprising:
treating a surface region of the vessel by exposing the surface region to a high-frequency plasma; and
coating the surface region of the vessel with a water-based edible coating.

2. The method of claim 1, wherein the high-frequency plasma is disposed at an angle in the range of about 0.1 degrees to about 90 degrees with respect to the surface region.

3. The method of claim 2, wherein the plasma is provided by a high-frequency plasma generator.

4. The method of claim 3, wherein the at least one high-frequency plasma generator includes a multitude of high-frequency plasma generator devices.

5. The method of claim 3, wherein one of the at least one high-frequency plasma generator devices emits a plasma charge that covers a first target region of the vessel, and another of the at least one additional high-frequency plasma generator devices emits a plasma charge that covers a second target region of the vessel.

6. The method of claim 5, wherein production efficiency is increased due to the use of more than one high-frequency plasma generator devices.

7. The method of claim 1, wherein the coating of the region of the vessel with the water-based mixture includes at least one selected from the group of dipping, spraying ad painting the vessel with the water-based mixture.

8. The method of claim 1, further comprising placing the vessel on a conveyor to facilitate the movement of the vessel through the high-frequency plasma.

9. The method of claim 1, further comprising utilizing a robotic arm or system to facilitate movement of the vessel through the high-frequency plasma.

10. The method of claim 1, further comprising rotating the vessel to expose different portions of the vessel to the a high-frequency plasma.

11. The method of claim 1, wherein the vessel is adapted to measure liquid pediatric medicine.

12. The method of claim 1, wherein the vessel comprises markings for measuring quantities of liquid placed in the vessel.

13. The method of claim 1, wherein the vessel is adapted for drinking beverages.

14. The method of claim 13, wherein the beverages comprise at least one selected from the group consisting of an alcoholic beverage, a mixed drink, a cocktail, juice, milk, water, and soda.

15. The method of claim 1, wherein the vessel is formed of a polymer selected from the group consisting of polypropylene, LDPE, HDPE and PTFE.

16. The method of claim 1, wherein the vessel is formed of a polymer having a surface energy below 38 mN/m.

17. The method of claim 1, further comprising superimposing a mask with at least one opening between the vessel and the high frequency plasma to control the area of the vessel exposed to the plasma.

18. A vessel treated in accordance with the method of claim 1.

19. The vessel of claim 18, in a form of a drinking cup or a medicine dispensing cup.

20. The vessel of claim 18, in a form of a drinking cup, wherein the surface region is a rim of the cup.

21. The vessel of claim 18, wherein the surface region is an exterior surface of the vessel.
